(19) United States
(12) Patent Application Publication
(10) Pub. No.: US 2024/0242879 A1
(43) Pub. Date: Jul. 18, 2024

(54) WINDING FOR HIGH-CURRENT MAGNETICS

(71) Applicant: New Berlin Technology Ltd. Co., New Berlin, WI (US)

(72) Inventor: Jonathan Michael Schaar, New Berlin, WI (US)

(21) Appl. No.: 18/410,433

(22) Filed: Jan. 11, 2024

Related U.S. Application Data
(60) Provisional application No. 63/438,904, filed on Jan. 13, 2023.

(51) Int. Cl. H01F 27/32; H01F 7/20; H01F 41/12

(52) U.S. Cl. CPC H01F 27/32; H01F 7/20; H01F 41/12

(57) ABSTRACT

An electrical winding comprises a first conductor, a second conductor, and a joint between the first and second conductors. The first conductor extends from a first end to a second end, the first end having geometry to interlink with the second end. The second conductor comprises a third end, the third end having geometry to interlink with the second end of the first conductor. The joint between the first conductor and the second conductor is characterized by a geometric interference between the second end of the first conductor and the third end of the second conductor.

### CROSS-REFERENCE TO RELATED APPLICATION(S)

This application claims the benefit of U.S. Provisional Application No. 63/438,904 filed Jan. 13, 2023, for “WINDING FOR HIGH-CURRENT MAGNETICS” by J. M. Schaar.

### BACKGROUND

Litz wire and planar magnetics are commonly used to avoid skin effect and proximity effect which raise the effective conductor resistance at high frequencies. Use of thin conductors such as foil and fine wire minimizes skin effect, which otherwise causes current to flow only near the surface of the conductor. In planar designs proximity effect is more dependent on relative distance between conductors and is addressed in winding layout.

Litz wire 100 (FIG. 1) is formed from many parallel wire strands 110, each strand being separately insulated. Litz wire can be very effective to mitigate skin and proximity effects. However, methods to produce Litz wire, form windings from Litz wire, and terminate Litz wire are time consuming and relatively expensive for high power, compact magnetic devices.

Planar magnetics use thin, wide conductors to achieve sufficient cross sectional area for a given load while mitigating skin effect. Windings for planar magnetics are produced by several methods. The PCB (printed circuit board) transformer 200 (FIG. 2) uses copper traces 210 on circuit boards 220 for windings together with a magnetic core 230. Multiple circuit board layers 240 allow for additional winding turns.

Windings formed from segmented conductors 300 (FIG. 3) using thin sheet metal 310 are also feasible but typically require multiple segment designs to make the taps 311, 312, 331, 332, 341 accessible between overlapped layers. Braze, weld or bolted fastening processes may be used to join adjacent layers outside the effective area of the winding. Insulation 320 is positioned between layers.

A continuous planar winding assembly 400 uses conductive foil in an edge-wound orientation (FIG. 4). Changing the direction of the winding (for instance, to shape the winding around a core with a rectangular cross section 410) requires a fold 440 in the foil to maintain a continuous conductive path through the full cross section of the material. The first side of the foil 420 and the second side of the foil 430 alternate orientation with each change of direction.

Power converters using semiconductor switches rely on inductive and capacitive components for basic operation and filtering in applications such as voltage source inverters, current source inverters, active rectifiers and DC-DC converters. Higher switching frequencies are desirable to enable use of smaller passive components (capacitors and inductors) because less energy is stored per switching cycle. However, high switching frequencies pose additional design challenges such as electromagnetic interference (EMI) and reduced electrical conductivity from skin effect and proximity effect.

### SUMMARY OF THE INVENTION

A winding is formed from individual sheet metal segments for each turn. A single segment is formed from a flat blank by removing material in the center to form a loop and slicing the loop apart to form interlinking geometry at the two ends of the segment. Multiple segments are assembled end to end with the interlinking geometry forming connections and serving as a mechanical and electrical joint. Secondary processes may be applied for additional joint integrity. Unlike planar windings of prior art, this design allows segments on consecutive layers/turns to be made from identical segment sections and a single segment forms a complete winding turn. Other segment shapes with interlinking geometry can be used with the full segments as start and end leads, taps, or to bridge to another section of the coil. Further, the interlinking geometry fit within the breadth of the winding conductor such that the design is more compact than planar designs requiring connections outside the active winding area. Additionally, the construction allows the designer to integrate a variety of insulation solutions, spacers and interleaved winding layouts for greater design flexibility to manage leakage inductance, cooling and proximity effect.

### BRIEF DESCRIPTION OF DRAWINGS

FIG. 1 is an illustration of Litz wire formed into a cable.

FIG. 2 is a diagram of planar windings on a printed circuit board for a transformer.

FIG. 3 is a diagram of a planar winding with laminated segments.

FIG. 4 is a section view of a continuous foil winding around a magnetic core.

FIG. 5 is a four part diagram of the steps to form an interlinking segment for a winding from a sheet of metal.

FIG. 6 is a diagram of several interlinking segments assembled into a multi-turn winding.

FIG. 7 is a diagram demonstrating several interlinking geometry profile options with examples of various positions on the sheet metal segment to locate a profile.

FIG. 8 is a diagram demonstrating secondary operations performed on interlinking profiles to reinforce the joint.

FIG. 9 is a diagram of a transformer with interleaved windings and winding spacers.

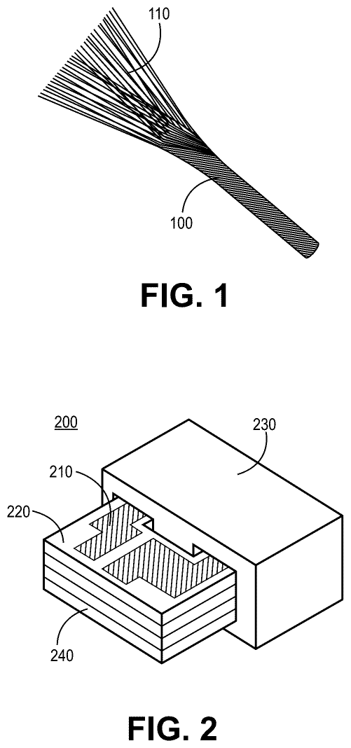

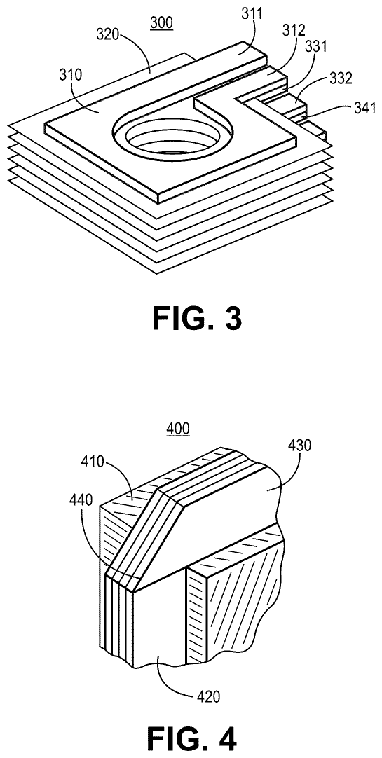

### DETAILED DESCRIPTION OF THE INVENTION

This disclosure pertains to magnetic device design and construction for use in inductors and transformers to enable reliable, efficient power conversion, particularly in the switching frequency range of 10 kHz-250 kHz. High efficiency, high power density and low cost are typical design goals for power converters. The disclosure addresses improvements in regard to design for manufacturability, space utilization and leakage flux management.

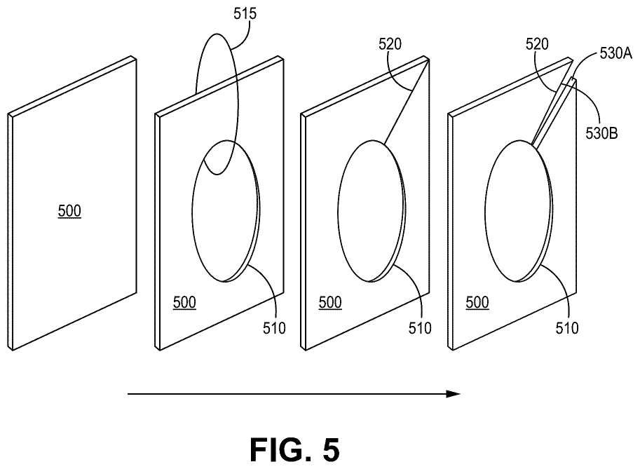

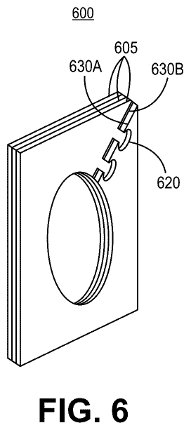

A winding for a magnetic device can be constructed from segments with interlinking geometry. Each segment is an electrical conductor. Each segment can be fabricated from homogenous material. FIG. 5 shows the conceptual progression for forming a segment from a flat sheet of metal 500. A “shorted” winding turn is formed when an inner section 510 is removed to create a continuous magnetic flux path 515 traveling through the open center portion of the sheet and returning around the outer perimeter. The shorted winding turn can be divided through one portion 520 from the inner perimeter defined by the removal of inner section 510 to the outer perimeter of the flat sheet of metal 500 resulting in a single winding turn with two ends 530A, 530B. Given two such winding segments, an opposite end (530A, 530B) of each segment can be connected to form a two-turn winding such that the end of one turn (e.g., 530A) interlinks with another end of the other turn (e.g., 530B) to form an electrical and mechanical joint. Further similar segments can be added to produce additional winding turns as shown in FIG. 6. FIG. 6 is a diagram of a multi-turn winding 600 in which several interlinking segments 605 are assembled. In the multi-turn winding 600, each segment 605 includes ends 630A and 630B with geometries to interlink with ends 630B and 630A, respectively, of adjacent segments 605. For example, end 630B of a first segment 605 has a geometry to interlink with end 630A of a second segment 605. Alternative winding segments with appropriate interlinking geometry 620 at ends 630A, 630B can connect to the main winding segments for use as start or finish or tap leads.

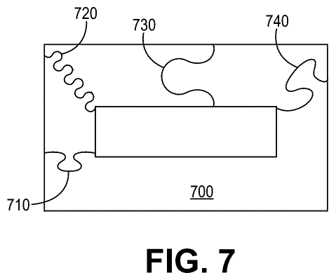

FIG. 7 illustrates a number of examples for interlocking geometry shapes and locations to orient the divide through segment 700. Profile design is important for mechanical strength and electrical conductivity of the winding. The geometry of the divide profile in segment 700 can include bulbous profiles (710, 720, 730, 740), for instance similar to the interlinking geometry of a jig-saw puzzle. Interlinking geometry with arc segments greater than 180 degrees yield secure connections. Divided profiles 710 and 740 are examples of geometry with arc segments greater than 180 degrees while profile 720 is an example with arc segments just over 180 degrees. Profile length influences contact surface area between interlinking geometry to help reduce the joint resistance, therefore corner locations, such as profile 720, or other diagonally oriented profiles can be beneficial. The maximum width of interlinking geometry can take into account the sheet thickness of the segment material. Higher width:thickness ratios in the profile, as in profile 730, are more prone to material buckling and subsequent loosening of the joint. On the other hand, lower width:thickness ratio profiles, as in profile 720, can be challenging for tool design and maintenance.

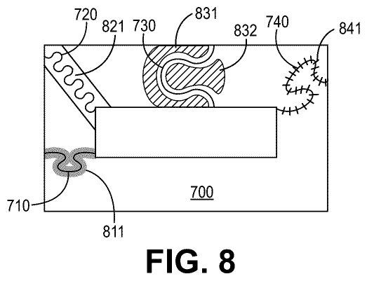

Copper and aluminum offer good formability properties as well as good electrical and thermal conductivity for winding construction. Any number of manufacturing processes may be used to form the interlinking geometry between conductor segments. The precision and small kerf of wire EDM are well-suited for this task, especially for small production volumes and avoidance of the time or cost to develop hard tooling. Similarly, waterjet cutting or laser cutting may be suitable processes. However, to maximize the interlinking area of the geometry, a process avoiding material removal can be used to divide the shorted winding turn and form the interlinking geometry from a sheet metal blank, such as shearing, stamping or fine blanking. An interference fit between the interlinking geometry of two connected turns is beneficial for mechanical and electrical joint performance, so a mechanical press can be required to generate the force to assemble two segments' ends together. A secondary process to displace the material of one or both interlinking geometries can strengthen the joint by tightening the fit between the two segments. FIG. 8 illustrates some examples of secondary operations performed on interlinking profiles to reinforce the joint. Applying substantial force to the entire region 821 around a profile can cause material displacement to tighten the joint. Compressing selective regions 831, 832 around the profile can cause the material flow to be directed toward the joint. Concentrating force in many locations 841 along the profile can also cause material deformation to tighten the joint. Another solution is to plate the interlocking geometry prior to assembly to build up the material and enhance the tightness of fit at the interlinking geometry. Plating can also protect the joint from corrosion which can mechanically or electrically weaken the joint. Other processes like brazing or welding 811 can also be applied to reinforce the joint after the segments are connected. However, the heat generated for these processes can damage nearby insulation and require additional equipment and training.

Windings requiring dielectric insulation can use solid insulation applied between turns or attached to the winding segments prior to connecting adjacent segments. Assembled windings can have turns temporarily spaced apart allowing them to be varnish dipped or spray coated if minimal insulation is required. Chemical processes are another method which can be applied to convert the surface of the winding to an insulating material, such as through aluminum anodizing. Alternatively, spacers attached to one side of the winding achieve turn-to-turn separation for gas or liquid insulation purposes or to manage leakage flux of the winding. Spacers without solid insulation also promote heat transfer for thermal management since the conductive surfaces are directly exposed to promote convection cooling.

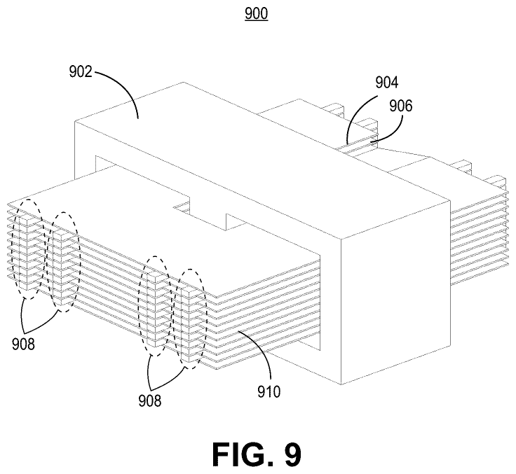

FIG. 9 illustrates transformer 900 with magnetic core 902, two interleaved windings 904 and 906, and winding spacers 908. Winding spacers 908 can extend a full length of each conductor segment 910 as illustrated in FIG. 9. Winding spacers 908 can be of any shape, configuration, and arrangement suitable to achieve a desired turn-to-turn separation. The architecture illustrated in FIG. 9 is possible because conductor segments 910 are rigid enough to contribute to their own support, in contrast, for example, to windings in which an insulation layer is primarily responsible for mechanical support. Winding spacers 908 can influence the leakage inductance of the winding, which is an important factor for use of high frequency transformers in power converters.

High current windings can benefit from additional strategies. A first strategy uses multiple segments in parallel with a thin film for insulation between them. The processes for forming the individual segments with interlinking geometry or the process for connecting consecutive segments can be suitable to process multiple layers simultaneously to reduce time and cost of manufacturing. Interleaved winding layouts can be used in transformers with multiple windings to mitigate proximity effect.

The use of clad or bi-metal materials can improve the performance and manufacturability of the winding. For instance, aluminum with a thin layer of copper attached on each side benefits from the higher conductivity of copper on the outer layers, in which high frequency current flows due to skin effect, while less expensive aluminum material improves mechanical and thermal performance compared to using thinner copper material alone. Utilizing sheet material thicker than that required to minimize skin effect can help achieve a desirable width:thickness ratio for the interlocking geometry. Further, providing more material at the joint increases the surface contact for lower electrical resistance and higher mechanical strength. Whereas planar windings of prior art oftentimes rely on the insulating materials for mechanical support throughout the windings, a thicker metal winding allows the conductor to be used structurally. With structural requirements fulfilled, at least in part by the winding, the insulation and requisite spacers separating the windings may be optimized for cost as well as dielectric and thermal performance.

A winding design and construction according to the present disclosure provides improvements for high frequency magnetic devices in high-power, semiconductor-based power converters with attention to design for manufacturability, space utilization and leakage flux management. A winding for a magnetic device is assembled from segments to mitigate limitations of planar magnetics. The prescribed joint between winding segments minimizes conductive resistance and provides a compact, reliable connection. The winding design and construction further enables design options for winding profiles, turn-to-turn spacing and interleaved windings to provide the designer flexibility to achieve leakage inductance, winding capacitance, cooling and other target parameters.

### Discussion of Possible Embodiments

The following are non-exclusive descriptions of possible embodiments of the present invention.

An electrical winding comprises a first conductor, a second conductor, and a joint between the first and second conductors. The first conductor extends from a first end to a second end, the first end having geometry to interlink with the second end. The second conductor comprises a third end, the third end having geometry to interlink with the second end of the first conductor. The joint between the first conductor and the second conductor is characterized by a geometric interference between the second end of the first conductor and the third end of the second conductor.

The electrical winding of the preceding paragraph can optionally include, additionally and/or alternatively, any one or more of the following features, configurations, and/or additional components:

An embodiment of the foregoing electrical winding can further include a third conductor, the third conductor comprising a fourth end having geometry to interlink with the first end of the first conductor.

In an embodiment of the electrical winding of any of the preceding paragraphs, the joint between the first conductor and the second conductor can be characterized by displaced material in the first conductor or the second conductor.

In an embodiment of the electrical winding of any of the preceding paragraphs, the at least one of the first conductor and the second conductor can comprise a homogenous material.

In an embodiment of the electrical winding of any of the preceding paragraphs, the at least one of the first conductor and the second conductor can comprise a clad or bi-metal material.

In an embodiment of the electrical winding of any of the preceding paragraphs, the joint between the first conductor and the second conductor can include plating on the first conductor or the second conductor.

An embodiment of the electrical winding of any of the preceding paragraphs can further include spacers.

An embodiment of the electrical winding of any of the preceding paragraphs can further include dielectric insulation.

In an embodiment of the electrical winding of any of the preceding paragraphs, the geometry of the first, second, and third ends can include one or more bulbous profiles having an arc segment greater than 180 degrees.

A method to build a magnetic device can include interleaving turns of one or more of the electrical winding of any of the preceding embodiments.

A method for building an electrical winding comprises providing a first conductor and a second conductor and forming a joint between the first and second conductors. The first conductor extends from a first end to a second end, the first end having geometry to interlink with the second end. The second conductor includes a third end, the third end having geometry to interlink with the second end of the first conductor. The joint between the first conductor and the second conductor is characterized by a geometric interference between the second end of the first conductor and the third end of the second conductor.

The method of the preceding paragraph can optionally include, additionally and/or alternatively, any one or more of the following features, configurations, additional components, and/or steps:

An embodiment of the foregoing method can further include applying dielectric insulation between the first conductor and the second conductor.

In an embodiment of the foregoing method, dielectric insulation can be applied after assembling the segments by dipping in or spraying with insulation.

In an embodiment of any of the foregoing methods, the dielectric insulation can be formed by anodizing or another chemical process to treat the conductor surfaces.

In an embodiment of any of the foregoing methods, dielectric insulation can be fixed to the first conductor or the second conductor before or after assembly.

In an embodiment of any of the foregoing methods, the joint can be reinforced.

In an embodiment of any of the foregoing methods, reinforcing the joint can include displacing material in the first conductor or the second conductor.

In an embodiment of any of the foregoing methods, reinforcing the joint can include brazing or welding the first conductor to the second conductor.

In an embodiment of any of the foregoing methods, the winding can be plated before or after assembly.

In an embodiment of any of the foregoing methods, the first end geometry or the third end geometry can be formed by shearing, or stamping, or fine blanking.

In an embodiment of any of the foregoing methods, the joint can be assembled with a tool.

1. An electrical winding comprising:
a first conductor, the first conductor extending from a first end to a second end, the first end having geometry to interlink with the second end;
a second conductor, the second conductor comprising a third end, the third end having geometry to interlink with the second end of the first conductor; and
a joint between the first conductor and the second conductor, wherein the joint is characterized by a geometric interference between the second end of the first conductor and the third end of the second conductor.

2. The electrical winding of claim 1, further comprising:
a third conductor, the third conductor comprising a fourth end having geometry to interlink with the first end of the first conductor.

3. The electrical winding of claim 1, wherein the joint between the first conductor and the second conductor is characterized by displaced material in the first conductor or the second conductor.

4. The electrical winding of claim 1, wherein the at least one of the first conductor and the second conductor comprises a homogenous material.

5. The electrical winding of claim 1, wherein the at least one of the first conductor and the second conductor comprises a clad or bi-metal material.

6. The electrical winding of claim 1, wherein the joint between the first conductor and the second conductor comprises plating on the first conductor or the second conductor.

7. The electrical winding of claim 1, further comprising spacers.

8. The electrical winding of claim 1, further comprising dielectric insulation.

9. The electrical winding of claim 1, wherein the geometry of the first, second, and third ends includes one or more bulbous profiles having an arc segment greater than 180 degrees.

10. A method for building an electrical winding comprises:
providing a first conductor, the first conductor extending from a first end to a second end, the first end having geometry to interlink with the second end;
providing a second conductor, the second conductor comprising a third end, the third end having geometry to interlink with the second end of the first conductor; and
forming a joint between the first conductor and the second conductor, wherein the joint is characterized by a geometric interference between the second end of the first conductor and the third end of the second conductor.

11. The method of claim 10, and further comprising applying dielectric insulation between the first conductor and the second conductor.

12. The method of claim 11, wherein the dielectric insulation is applied after assembling the segments by dipping in or spraying with insulation.

13. The method of claim 11, wherein the dielectric insulation is formed by anodizing or another chemical process to treat the conductor surfaces.

14. The method of claim 11, wherein dielectric insulation is fixed to the first conductor or the second conductor before or after assembly.

15. The method of claim 10, wherein the joint is reinforced.

16. The method of claim 15, wherein reinforcing the joint comprises displacing material in the first conductor or the second conductor.

17. The method of claim 15, wherein reinforcing the joint comprises brazing or welding the first conductor to the second conductor.

18. The method of claim 10, wherein the winding is plated before or after assembly.

19. The method of claim 10, wherein the first end geometry or the third end geometry is formed by shearing, or stamping, or fine blanking.

20. A method to build a magnetic device, the method comprising interleaving turns of one or more of the electrical winding of claim 1.
